(19) United States
(12) Patent Application Publication
(10) Pub. No.: US 2004/0201528 A1
(43) Pub. Date: Oct. 14, 2004

(54) Integrated antenna for portable computer

(75) Inventors: Cheng-Han Lee, Hsin-Tien City (TW); Tsung-Wen Chiu, Kaohsiung City (TW)

Correspondence Address: SENNIGER POWERS LEAVITT AND ROEDEL, ONE METROPOLITAN SQUARE, 16TH FLOOR, ST LOUIS, MO, 63102, US

(73) Assignee: Yageo Corporation

(21) Appl. No.: 10/636,022

(22) Filed: Aug. 7, 2003

(30) Foreign Application Priority Data
Apr. 8, 2003 (TW) 092108007

(51) Int. Cl. H01Q 1/24

(52) U.S. Cl. 343/702; 343/700 MS

(57) ABSTRACT

The invention relates to an integrated antenna for a portable computer. The portable computer has a display and a display frame. The integrated antenna comprises a first radiating metal strip, a second radiating metal strip, a ground plane, at least one first connecting metal strip and a second connecting metal strip. The first radiating metal strip is used to provide a first resonance, and the second radiating metal strip is used to provide a second resonance. The first connecting metal strip connects the first radiating metal strip and the second radiating metal strip. The second connecting metal strip connects the second radiating metal strip and the ground plane. The integrated antenna of the invention is mounted to the display frame of the portable computer. The ground plane of the antenna can provide with ground of the integrated antenna. The integrated antenna does not need to connect to a grounding terminal of the display frame, and the mounted position of the integrated antenna is adjustable. Besides, the integrated antenna can have stable electrical characteristics.

### BACKGROUND OF THE INVENTION

1. Field of the Invention

The present invention relates to an antenna, more particularly, to an integrated antenna for a portable computer.

2. Description of the Related Art

In recent years, portable wireless communications devices are becoming increasingly popular. Almost all products must have wireless communication capability. For a portable computer, wireless communication can reduce the connection wires and solve the problem of setting parameters for hardware of the portable computer. To obtain the function of wireless communication, it is necessary to install an antenna on the portable computer. It is important for a portable computer to include a well designed antenna attached to an adequate location thereof.

Referring to FIG. 1, according to U.S. Pat. No. 6,339,400 B1, antennas 11 and 12 are disposed around a display 10 of a portable computer 1. However, a grounding terminal of the antennas 11 and 12 must be connected to the metal frame for grounding the antennas 11 and 12. Therefore, the mounted position of the conventional antenna is restricted to the metal frame, and cannot be changed to other places.

Therefore, it is necessary to provide an innovative and progressive integrated antenna so as to solve the above problem.

### SUMMARY OF THE INVENTION

One objective of the present invention is to provide an integrated antenna for a portable computer. The portable computer has a display and a display frame. The integrated antenna comprises a substrate, a first radiating metal strip, a second radiating metal strip, a ground plane, at least one first connecting metal strip and a second connecting metal strip. The substrate has a first surface and a connecting portion for connecting to the display frame. The first radiating metal strip is used to provide a first resonance, and the second radiating metal strip is used to provide a second resonance, with respect to the first radiating metal strip and spaced at a distance from the first radiating metal strip. The ground plane is spaced at a distance from the second radiating metal strip and with respect to the second radiating metal strip. The first connecting metal strip connects the first radiating metal strip and the second radiating metal strip. The second connecting metal strip connects the second radiating metal strip and the ground plane.

The integrated antenna of the invention is mounted to the display frame of the portable computer. The ground plane of the antenna can provide ground of the integrated antenna. The integrated antenna does not need to connect to a grounding terminal of the display frame, and the mounted position of the integrated antenna is adjustable. Besides, the integrated antenna can have stable electrical characteristics.

Furthermore, the integrated antenna can be operated in multi-band and has high radiation efficiency and stable performance. Additionally, because the first radiating metal strip, the second radiating metal strip and the ground plane are formed on the first surface of the substrate, the integrated antenna can be easily manufactured and there is no problem for positioning the above elements and the substrate so as to reduce the error of the integrated antenna.

### BRIEF DESCRIPTION OF THE DRAWINGS

FIG. 1 illustrates a conventional antenna disposed on a display of a portable computer.

FIG. 2A shows an integrated antenna disposed on a display frame of a portable computer, according to the invention.

FIG. 2B shows an enlarged partial perspective view of illustrating an integrated antenna disposed on a display frame of a portable computer, according to the invention.

FIG. 3 shows the perspective view of an integrated antenna, according to the first embodiment of the invention.

FIG. 4 shows the perspective view of an integrated antenna, according to the second embodiment of the invention.

FIG. 5 shows the perspective view of an integrated antenna, according to the third embodiment of the invention.

FIG. 6 shows the perspective view of an integrated antenna, according to the fourth embodiment of the invention.

FIG. 7 shows the perspective view of an integrated antenna, according to the fifth embodiment of the invention.

### DETAILED DESCRIPTION OF THE INVENTION

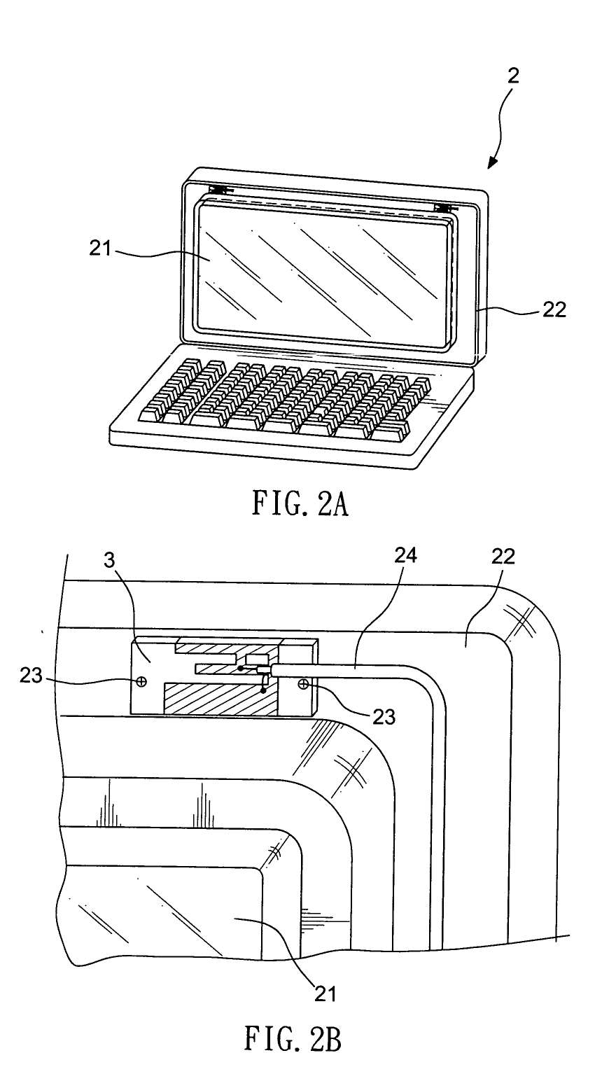

Referring to FIGS. 2A and 2B, according to the invention, a portable computer 2 has a display 21 and a display frame 22. An integrated antenna 3 is mounted on the display frame 22 of the portable computer 2. Two integrated antennas 3 can each be mounted on one side of the display frame 22, respectively, so as to obtain better communication between the portable computer 2 and peripheral equipments.

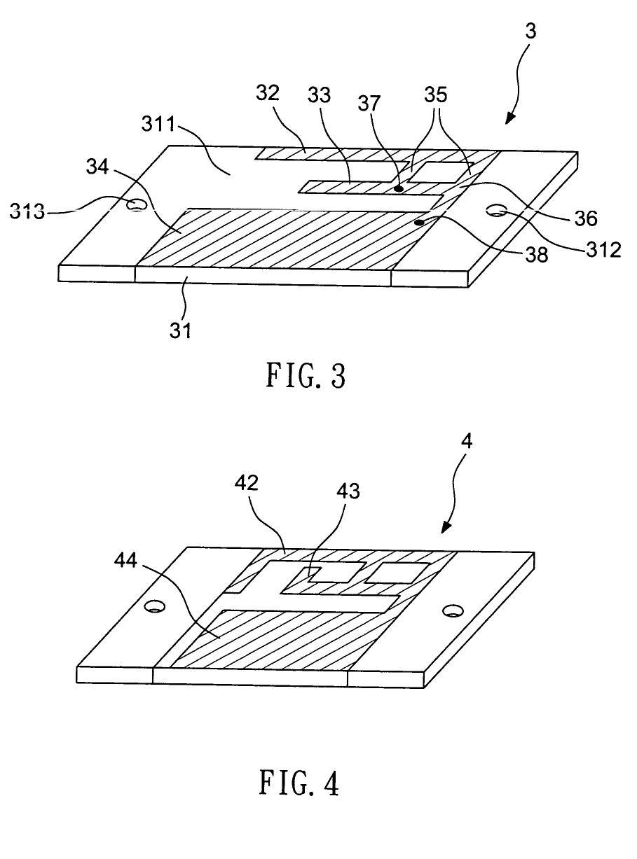

Referring to FIG. 3, the integrated antenna 3 comprises a substrate 31, a first radiating metal strip 32, a second radiating metal strip 33, a ground plane 34, two first connecting metal strips 35 and a second connecting metal strip 36. The substrate 31 has a first surface 311 and two connecting portions 312 and 313. The connecting portions 312 and 313 are used for connecting to the display frame 22. The connecting portions 312 and 313 are holes penetrating through the substrate 31. The holes are used to receive screws 23 to fix the integrated antenna 3 on the display frame 22 of the portion computer 2, as shown in FIG. 2B.

The first radiating metal strip 32 of the integrated antenna 3 is formed on the first surface 311 of the substrate 31, and is used to provide a first resonance (low frequency). The second radiating metal strip 33 is formed on the first surface 311 of the substrate 31 and disposed adjacent to the first radiating metal strip 32, and is used to provide a second resonance (high frequency). The first radiating metal strip 32 is spaced at a distance from the second radiating metal strip 33, and is substantially parallel to the second radiating metal strip 33.

The ground plane 34 is formed on the first surface 311 of the substrate 31 and disposed adjacent to the second radiating metal strip 33. The ground plane 34 is spaced at a distance from the second radiating metal strip 33, and is substantially parallel to the second radiating metal strip 33. The ground plane 34 provides the ground of the antenna.

The first connecting metal strip 35 connects the first radiating metal strip 32 and the second radiating metal strip 33, and is formed on the first surface 311 of the substrate 31. The first connecting metal strip 35 is substantially perpendicular to the first radiating metal strip 32 and the second radiating metal strip 33. The integrated antenna 3 has two first connecting metal strips 35 connecting to the first radiating metal strip 32 and the second radiating metal strip 33 on a middle portion and a side of the substrate 31, respectively.

The second connecting metal strip 36 connects the second radiating metal strip 33 and the ground plane 34, and is formed on the first surface 311 of the substrate 31. The second connecting metal strip 36 is substantially perpendicular to the second radiating metal strip 33 and the ground plane 34. The second connecting metal strip 36 connects the second radiating metal strip 33 and the ground plane 34 on a side of the substrate 31.

According to the first embodiment of the invention, the second radiating metal strip 33 further comprises a feed portion 37 for connecting a signal terminal of a coaxial cable 24, as shown in FIG. 2B. The ground plane 34 further comprises a ground portion 38 for connecting a ground terminal of the coaxial cable 24, as shown in FIG. 2B. The coaxial cable 24 is used to connect the integrated antenna 3 to a control circuit of the portable computer 2 so as to utilize the integrated antenna 3 to process communications with peripheral equipments.

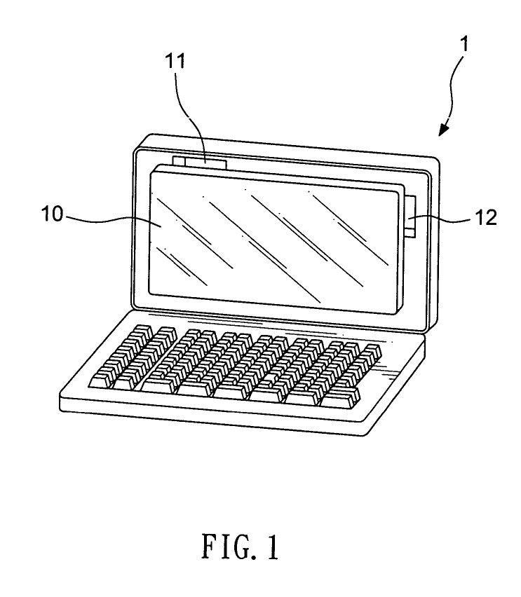

Compared with the conventional antennas 11, 12 disposed on the display 10 of the portable computer 1, as shown in FIG. 1, and the conventional antennas 11, 12 connected to the grounding terminal of the portable computer 1, because the integrated antenna 3 does not need to connect to a grounding terminal of the display frame 22, the integrated antenna 3 can be mounted to any place of the display frame 22. Therefore, the mounted position of the integrated antenna is not restricted to the grounding position of the display frame 22, and the mounted position of the integrated antenna is adjustable. Furthermore, the integrated antenna 3 can be operated in multi-band and has high radiation efficiency and stable performance. The integrated antenna 3 can be mounted easily on the display frame 22 of the portable computer 2.

Additionally, because the first radiating metal strip 32, the second radiating metal strip 33 and the ground plane 34 are formed on the first surface 311 of the substrate 31, the integrated antenna 3 can be easily manufactured and there is no problem for positioning the above elements and the substrate for reducing the error of the integrated antenna 3.

Referring to FIG. 4, according to the integrated antenna 4 of the second embodiment of the invention, the difference between the integrated antenna 4 of the second embodiment and the integrated antenna 3 of the first embodiment is that the first radiating metal strip 42 further comprises a first extending portion extending toward the ground plane 44, and the second radiating metal strip 43 further comprises a second extending portion extending toward the first radiating metal strip 42.

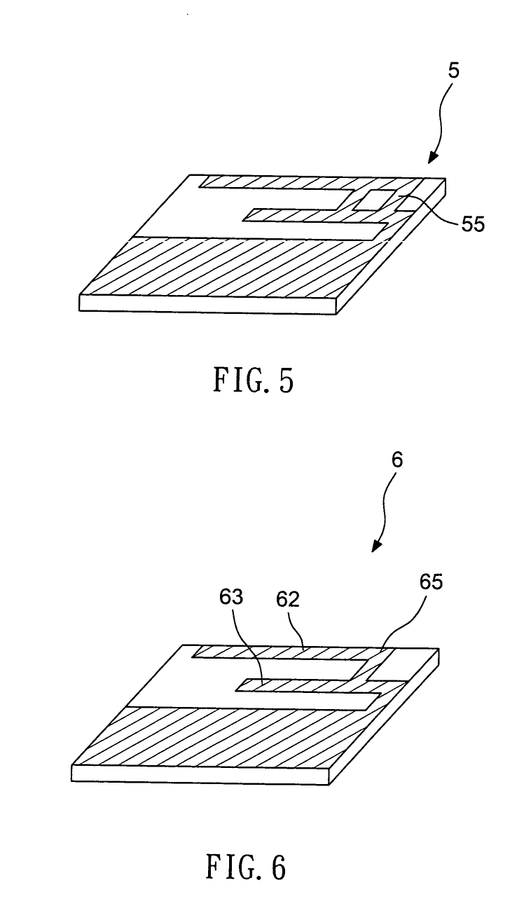

Referring to FIG. 5, according to the integrated antenna 5 of the third embodiment of the invention, the difference between the integrated antenna 5 of the third embodiment and the integrated antenna 3 of the first embodiment is that the first connecting metal strip 55 is not on the side of the substrate 51, and is spaced at a distance away from the side of the substrate 51.

Referring to FIG. 6, according to the integrated antenna 6 of the fourth embodiment of the invention, the difference between the integrated antenna 6 of the fourth embodiment and the integrated antenna 3 of the first embodiment is that the integrated antenna 6 has only a first connecting metal strip 65, and the first connecting metal strip 65 is not on the side of the substrate 61, and is spaced at a distance away from the side of the substrate 61.

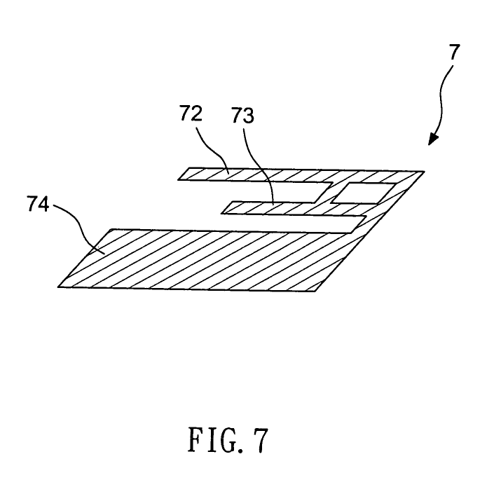

Referring to FIG. 7, according to the integrated antenna 7 of the fifth embodiment of the invention, the difference between the integrated antenna 7 of the fifth embodiment and the integrated antenna 3 of the first embodiment is that the integrated antenna 7 does not have the substrate 31 of the first embodiment, but only a first radiating metal strip 72, a second radiating metal strip 73, a ground plane 74, two first connecting metal strips and a second connecting metal strip. That is, the integrated antenna 7 utilizes air as the dielectric.

Besides, the integrated antenna 5 of the third embodiment, the integrated antenna 6 of the fourth embodiment and the integrated antenna 7 of the fifth embodiment do not have the connecting portion as the integrated antenna 3 of the first embodiment. They are adhered to the display frame of the portable computer.

While an embodiment of the present invention has been illustrated and described, various modifications and improvements can be made by those skilled in the art. The embodiment of the present invention is therefore described in an illustrative but not restrictive sense. It is intended that the present invention may not be limited to the particular forms as illustrated, and that all modifications which maintain the spirit and scope of the present invention are within the scope as defined in the appended claims.

What is claimed is:

1. An integrated antenna for a portable computer, the portable computer having a display and a display frame, the integrated antenna mounted on the display frame, the integrated antenna comprising:
a first radiating metal strip, for providing a first resonance;
a second radiating metal strip, disposed adjacent to the first radiating metal strip and spaced at a distance therefrom for providing a second resonance;
a ground plane, disposed adjacent to the second radiating metal strip and spaced at a distance therefrom;
at least one first connecting metal strip, connecting to the first radiating metal strip and the second radiating metal strip; and
a second connecting metal strip, connecting to the second radiating metal strip and the ground plane.

2. The integrated antenna according to claim 1, further comprising a substrate having a first surface and at least one connecting portion; the first radiating metal strip, the second radiating metal strip, the ground plane, the first connecting metal strip and the second connecting metal strip being formed on the first surface of the substrate, the connecting portion being used for connecting to the display frame of the portable computer.

3. The integrated antenna according to claim 1, wherein the second radiating metal strip further comprises a feed portion for connecting a signal terminal of a coaxial cable, and the ground plane further comprises a ground portion for connecting a ground terminal of the coaxial cable.

4. The integrated antenna according to claim 1, wherein the first radiating metal strip is spaced at a distance from the second radiating metal strip, and is substantially parallel to the second radiating metal strip.

5. The integrated antenna according to claim 1, wherein the second radiating metal strip is spaced at a distance from the ground plane, and is substantially parallel to the ground plane.

6. The integrated antenna according to claim 1, wherein the first radiating metal strip further comprises a first extending portion extending toward the ground plane, and the second radiating metal strip further comprises a second extending portion extending toward the first radiating metal strip.

7. The integrated antenna according to claim 1, wherein the connecting portion has a hole penetrating through the substrate, and the hole is used to receive a screw to fix the integrated antenna on the display frame of the portion computer.
